(19) United States
(12) Patent Application Publication
(10) Pub. No.: US 2025/0198245 A1
(43) Pub. Date: Jun. 19, 2025

(54) SYSTEMS AND METHODS USING EXPANDABLE GROUT FOR IMPROVED LOST CIRCULATION CONTROL

(71) Applicant: Chevron U.S.A. Inc., San Ramon, CA (US)

(72) Inventors: Michael James Fuller, Cypress, TX (US); John B. Trenery, JR., Sugar Land, TX (US); Peter James Clark, The Woodlands, TX (US); Douglas Cory Arceneaux, Katy, TX (US); Shannon Kirstin Stocks, Alvin, TX (US); William Dale Wood, Montgomery, TX (US)

(21) Appl. No.: 18/545,365

(22) Filed: Dec. 19, 2023

(51) Int. Cl. E21B 21/00; C09K 8/508; C09K 8/518

(52) U.S. Cl. CPC E21B 21/003; C09K 8/5086; C09K 8/518; C09K 2208/08

(57) ABSTRACT

Systems for deploying expandable grout in a downhole assembly to prevent lost circulation are described. Methods are described that prevent lost circulation in hydraulic fracturing by filling fractures with an expanding grout mixture.

### FIELD OF THE DISCLOSURE

The present disclosure relates to a system for deploying expandable grout in a wellbore to prevent lost circulation.

### BACKGROUND

The drilling industry spends millions of dollars per year treating and managing lost circulation during drilling operations. There are many lost circulation treatment techniques available, including any of a series of solid particulate lost-circulation materials (LCM) that can be added to drilling fluids being transported to pack off fractures and zones of losses downhole. Selection of these methods is based upon the rate and conditions of the losses. However, massive losses (>30 bbl/hr for nonaqueous drilling fluid, or >100 bbl/hr for water-based mud) continue to be a costly problem. Current techniques have difficulty treating massive losses due to the particle size limitations stipulated by the downhole equipment used during the drilling operation. One technique employed to cure massive losses is cement. Cementing procedures, while effective at curing the losses, can also be a costly procedure. Crosslinking polymers are another solution to curing massive lost circulation, however these polymers are very difficult to apply in the field and they require detailed engineering, which often takes time to complete.

These and other deficiencies exist. Therefore, there is a need to provide [invention] that overcome these deficiencies.

### SUMMARY OF THE DISCLOSURE

In some aspects, the techniques described herein relate to an expandable polyurethane grout system for controlling lost circulation during drilling operations, including: a first precursor component including a polyol; a second precursor component including an isocyanate; wherein the first and second precursor components are configured to be combined with agitation downhole in a controlled manner; wherein the combination of the first and second precursor components results in a chemical reaction that causes expansion of the grout; wherein the expanded grout system undergoes a hardening polymerization to form structure with heightened compressive strength, optionally a closed-cell structure; and wherein the expanded grout system physically adheres to formation grains and fracture faces, providing high shear bond strength;

In some aspects, the techniques described herein relate to an method for employing an expandable polyurethane grout system for controlling lost circulation during drilling operations, including: combining one or more grout precursors in a downhole wellbore where one or more fractures have been exposed during drilling operations; wherein the combination of the grout precursors transports into the porosity of exposed fractures; wherein the combination of the grout precursors results in a chemical reaction that causes expansion of the grout; wherein the expanded grout system undergoes a hardening polymerization to form a closed cell structure; and wherein the expanded grout system physically adheres to one or more formation grains and the fracture faces.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments of the invention.

FIG. 1A illustrates a grout system 100 according to an exemplary embodiment.

FIG. 1B illustrates a grout system 100 according to an exemplary embodiment.

FIG. 1C illustrates a grout system 100 according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features, advantages, and characteristics of an embodiment. In other instances, additional features, advantages, and characteristics may be recognized in certain embodiments that may not be present in all embodiments. One skilled in the relevant art will recognize that the features, advantages, and characteristics of any embodiment can be interchangeably combined with the features, advantages, and characteristics of any other embodiment.

The flowchart and block diagrams in the figures illustrate the architecture, functionality, and operation of possible implementations of systems and method according to various embodiments of the present invention.

Expandable grout solutions have been recently investigated for a number of subterranean applications. These systems which generally comprise expandable polyurethane systems possess numerous chemical and physical features which could add value in a wider range of applications. Specifically, two component polyurethane grout materials undergo an expansion that may range from 2 to 20 fold the original volume of the liquid precursors. The expanded grout undergoes a hardening polymerization that often yields a closed cell structure with low permeability. Grouts are also known to physically and or chemically bond to the formation, cement, and the metal casing or tubing leading to high shear bond strength.

The current invention discloses uses of expandable polyurethane grout as an effective alternative for treating massive lost circulation during drilling. Lost circulation can refer to an uncontrolled flow of drilling fluid, which may be oil-based or water based, deep into the target formation outside from its desired location, e.g. remaining in the wellbore during drilling to lubricate the bit and transport cuttings. Thus, the well “loses” fluid to the formation, including into exposed fractures. In one embodiment, an expandable grout could be pumped as a pill that could be used to seal a loss-zone or formation with exposed fractures of dimensions that conventional lost circulation materials are less effective to seal. Lost circulation material (“LCM”) includes solid material intentionally introduced into wellbore system to prevent losses from occurring. Conventionally, LCMs are not expandable, don't bond to surfaces, and rarely set or harden. For example, some conventional LCMs include fibrous material such as tree bark and shredded cane stalk; flaky materials such as mica flakes; and granular materials such as marble, wood, and nut hulls.

The expansion of the polyurethane will occur against the walls of any fractures or pore spaces into which it has packed during injection. The physical expansion along with the chemical adhesion of the polyurethane to formation grains and fracture faces will create high resistance to further losses during the drilling or completions activity. The injectivity of expandable grout into a formation or zone will be easier than conventional LCM solutions due to the lack of entrained solids and will create a viscous or solid barrier upon curing. The pumping of a liquid blend of polyurethane precursors for enhanced lost circulation control also alleviates the particle size limitations presented in conventional techniques that use sized solid lost circulation materials (during drilling or cementing).

In other embodiments, the blend of expandable polyurethane precursors could be used in conjunction with conventional lost circulation material fibers such as fibers, flakes, and or granular material and the combination pumped into an exposed fracture in the formation. The composite material on curing would physically and chemically seal the fracture tip and prevent fracture propagation. Additions of conventional lost circulation material could bond to the grout improving the strength and bonding of the combined seal and ultimately improving lost circulation control over just the polyurethane grout or conventional LCM alone. In an optional embodiment that may accompany the afore described embodiments the injection of the polyurethane precursor blend may immediately precede a short time for shut in in order to allow the polyurethane to undergo full expansion and subsequent curing to form a hardened low permeability mass. During this injection and shut in, the primary drilling would cease and the drill string could optionally be pulled upward, followed by injection of the precursor blend into the loss zone and shut in to cure and harden the grout. Following this shut in, subsequent drilling or completions activities can resume and will experience reduced fluid losses.

In the current invention, the expandable grout precursors may be added to the downhole fluids to control lost circulation in a number of ways. In some embodiments the two precursor components could be added singly into the drilling or completion fluid undergoing losses with only the mixing energy of the fluid shear downhole to combine the components adequately. In an alternative embodiment the two precursors are co-injected simultaneously and then pass through a mixing chamber before the blend is added into the flowing stream of drilling or completion fluids in transit downhole. In an alternative embodiment, flexible bladders or balloons containing the separate precursors are deployed through the drill string; upon shearing during passing through the drill bit apertures, the precursors are released and can react downhole, undergoing transit into the fracture. In a final embodiment, the two polyurethane precursors should be encapsulated separately, and the two encapsulated precursors added together to the flowing stream of drilling or completion fluids during drilling. The encapsulated precursor solids would pack together into a fracture or a zone of lost circulation, and when the capsules shatter, the two precursors could combine downhole and undergo expansion and hardening per the embodiments above.

Massive lost circulation events have occurred globally in multiple asset types including deep water; shale & tight; and conventional assets such as sandstones and/or carbonates. While these events are relatively low frequency, they can be very costly, typically costing millions of dollars per event and even in some cases leading to a loss of wellbore. As an example, these events can also pose HES risks as wellbore stability can be compromised if the loss zone is below a pressurized zone, then the inability to maintain hydrostatic pressure in the wellbore could lead to uncontrolled hydrocarbon release.

This system offers several benefits and improvements over conventional systems and methods. The system provides an effective sealing of fractures and gaps. The expandable polyurethane grout undergoes controlled expansion when injected into loss zones during drilling. This expansion allows the grout to fill fractures, gaps, and pore spaces within the formation, creating a barrier that significantly reduces the potential for further fluid loss during drilling or completion activities. Additionally, the grout provides enhanced adhesion and bonding. The chemical adhesion of the polyurethane grout to both formation grains and fracture faces results in a strong bond. This bond enhances the sealing effect and contributes to high shear bond strength, reducing the risk of fluid escaping into unintended areas. The grout's ability to effectively seal larger fracture sizes and spaces that traditional materials might not be able to address can lead to substantial cost savings by preventing losses and minimizing downtime. The expandable polyurethane grout can be used in various formations and well types, including deep-water; shale & tight assets; and conventional carbonates. This versatility increases its potential applicability across different drilling environments. Moreover, the grout systems improve wellbore stability by preventing fluid loss and maintaining hydrostatic pressure. This reduces the risk of wellbore collapse and the potential for uncontrolled hydrocarbon releases, thereby addressing safety and environmental concerns. The systems may also reduce pumping challenges typical in conventional systems: the absence of entrained solids in the grout simplifies its injection into formations, making the process easier compared to conventional lost circulation materials that contain solids of specific sizes. Alternatively, the polyurethane grout can be combined with conventional lost circulation materials such as fibers and granular materials. The resulting composite material seals fractures and prevents their propagation, further enhancing lost circulation control through reduced permeability and enhanced shear bond strength in the composite. The quick expansion and subsequent hardening of the polyurethane grout/LCM-composite, especially when followed by a brief shut-in period, lead to a rapidly formed low permeability mass. This allows drilling or completion activities to resume with reduced fluid losses and minimal interruption. The invention offers flexibility in injecting the polyurethane precursors. These can be added separately and mixed through fluid shear downhole; co-injected and mixed before addition to the fluid stream; deployed through flexible bladders through the drill bit; or encapsulated and combined downhole to trigger expansion and hardening.

Overall, the expandable polyurethane grout invention presents a novel and versatile solution for addressing lost circulation issues during drilling operations. Its ability to effectively seal fractures, enhance bonding, reduce fluid losses, and contribute to improved wellbore stability has the potential to significantly improve operational efficiency and cost-effectiveness while mitigating safety and environmental risks.

The expandable polyurethane grout invention can find application in a variety of drilling operations and wellbore activities, particularly when dealing with lost circulation challenges. In deep-water drilling, the formations encountered can be highly complex and prone to lost circulation due to the presence of fractures and large voids. The expandable polyurethane grout can be injected to seal these fractures and prevent drilling fluid losses, maintaining wellbore stability and preventing costly downtime. Shale formations often have natural fractures that can lead to lost circulation. The polyurethane grout can be employed to seal these fractures, enhancing wellbore integrity and preventing the escape of large volumes of critical drilling mud into unintended zones. Drilling in tight reservoirs, such as unconventional oil and gas plays, can also lead to lost circulation due to the formation's low permeability. The expandable grout can help mitigate these losses by sealing small fractures and pore spaces. Even in conventional reservoirs, lost circulation can occur when drilling through porous and fractured formations. The grout can be injected to prevent fluid losses and maintain pressure integrity. In situations where wellbore stability is compromised due to lost circulation, injecting the polyurethane grout can strengthen the wellbore and mitigate the risk of collapse or wellbore wall damage. In horizontal and directional drilling, these drilling techniques can encounter challenges related to fluid losses, especially as the wellbore traverses different rock types and formations. The expandable grout can be used to seal off potential pathways for fluid escape. In lost circulation zones, some formations are particularly prone to lost circulation due to their geological characteristics. In these cases, using the expandable grout can help plug the loss zones effectively. In managed pressure drilling, drilling involves controlling the pressure in the wellbore to prevent kicks and losses. The expandable polyurethane grout can play a role in managing pressure by reducing or eliminating fluid losses. In underbalanced drilling, maintaining pressure integrity becomes crucial. The grout can help prevent fluid losses and maintain desired pressure levels. Overall, the expandable polyurethane grout technology can be used in a wide range of wellbore activities and drilling scenarios where lost circulation is a concern. Its ability to seal fractures, enhance bonding, and maintain wellbore stability makes it a versatile solution for improving operational efficiency, minimizing downtime, and reducing risks in various drilling environments.

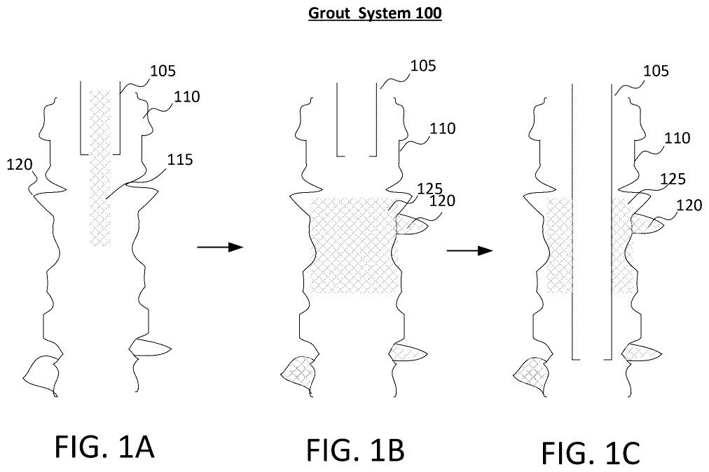

FIGS. 1A-1C illustrate a grout system 100 according to an exemplary embodiment. In FIG. 1A, a drill string 105 placed within a wellbore 110 with an openhole formation face can release a mixture of grout precursors 115 at or near one or more fractures 120. The polyurethane precursor blend 115 can be comprised of any material specified herein. In some embodiments, the polyurethane blend is premixed and released as a single injection into the wellbore 110. In other embodiments, the grout is released as two streams from the drill string, then combined in the wellbore. In other embodiments, flexible bladders or balloons containing the separate precursors are deployed through the drill string; upon shearing during passing through the drill bit apertures, the precursors are released and can react downhole, undergoing transit into the fracture. In still other embodiments, the polyurethane precursors can be deployed as one or more capsules which contain the separate precursors that combine to form the grout after release from the capsules. In FIG. 1B, the grout 115 expands and hardens in 125 to fill a portion of the wellbore 110 as well as the one or more fractures 120. In FIG. 1C, the drill string 105 can, upon the hardening of the grout 125, proceed with drilling further down the wellbore 110 without disturbing the hardened grout in the one or more fractures 120.

In some aspects, the techniques described herein relate to an expandable polyurethane grout system for controlling lost circulation during drilling operations, including: a first precursor component including a polyol; a second precursor component including an isocyanate; wherein the first and second precursor components are configured to be combined downhole in a controlled manner; wherein the combination of the first and second precursor components results in a chemical reaction that causes expansion of the grout; wherein the expanded grout system undergoes a hardening polymerization to form a closed cell structure; and wherein the expanded grout system physically adheres to formation grains and fracture faces, providing high shear bond strength;

In some aspects, the techniques described herein relate to a system, wherein the grout expands by a factor ranging from 2 to 20 times its original volume.

In some aspects, the techniques described herein relate to a system, wherein the grout once hardened has low permeability.

In some aspects, the techniques described herein relate to a system, wherein the expanded grout system is used in sealing naturally or hydraulically fractured zones or formations with fractures induced during drilling or completions.

In some aspects, the techniques described herein relate to a system, wherein the grout system can be used in conjunction with at least one selected from the group of conventional lost circulation materials that comprise fibers, flakes, or granular materials to further improve sealing and bonding.

In some aspects, the techniques described herein relate to a system, wherein the grout system is applicable during drilling activities to access deep water formations.

In some aspects, the techniques described herein relate to a system, wherein the grout system is applicable during drilling activities to access conventional sandstone or carbonate formations.

In some aspects, the techniques described herein relate to a system, wherein the grout system, upon injection and curing, prevents fracture propagation and maintains wellbore stability.

In some aspects, the techniques described herein relate to a system, wherein the grout system reduces fluid losses during drilling or completions activities, thereby minimizing operational disruptions and risks associated with uncontrollable fluid release.

In some aspects, the techniques described herein relate to a system, wherein the grout system is injected using a single injection stream of pre-mixed grout.

In some aspects, the techniques described herein relate to a system, wherein the grout system is injected using a simultaneous injection during which the grout is mixed while being pumped into the wellbore.

In some aspects, the techniques described herein relate to a system, wherein the grout system is deployed using flexible bladders or balloons containing the separate precursors are deployed through the drill string. Upon shearing during transit through the drill bit apertures, the precursors are released and can react downhole, undergoing transit into the fracture.

In some aspects, the techniques described herein relate to a system, wherein the grout system is injected using encapsulated precursors configured with a coating intended to degrade, release the precursors, and adhere to the fractures.

In some aspects, the techniques described herein relate to a system, wherein the grout system provides enhanced lost circulation control by creating an impermeable or solid barrier upon curing.

In some aspects, the techniques described herein relate to an method for employing an expandable polyurethane grout system for controlling lost circulation during drilling operations, including: combining one or more grout precursors in a downhole wellbore including one or more fractures; wherein the combination of the grout precursors results in a chemical reaction that causes expansion of the grout; wherein the expanded grout system undergoes a hardening polymerization to form a closed cell structure; and wherein the expanded grout system physically or chemically bonds to one or more formation grains and the fracture faces.

In some aspects, the techniques described herein relate to a system, wherein the grout is injected using a single injection stream of pre-mixed grout where precursors are combined and agitated on the surface.

In some aspects, the techniques described herein relate to a system, wherein the grout system is injected using encapsulated precursors configured to experience rupture or degradation of encapsulation, release the precursors, and adhere to the fractures.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above-described embodiments, method, and examples, but by all embodiments within the scope and spirit of the invention as claimed.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper,” “lower,” “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. An expandable polyurethane grout system for controlling lost circulation during drilling operations, comprising:
a first precursor component comprising a polyol; and
a second precursor component comprising an isocyanate;
wherein the mixture of first and second precursor components are configured to be deployed downhole in a controlled manner;
wherein the combination of the first and second precursor components results in a chemical reaction that causes expansion of the grout;
wherein the expanded grout system undergoes a hardening polymerization to form a closed cell structure; and
wherein the expanded grout system physically adheres to formation grains and fracture faces, providing high shear bond strength and low permeability.

2. The system of claim 1, wherein the grout expands by a factor ranging from 2 to 20 times its original volume.

3. The system of claim 1, wherein the grout once hardened has low permeability.

4. The system of claim 1, wherein the expanded grout system is used in sealing fractured zones or formations with induced or hydraulic fractures.

5. The system of claim 1, wherein the grout system can be used in conjunction with at least one selected from the group of material fibers, flakes, or granular materials to further improve sealing and bonding.

6. The system of claim 1, wherein the grout system is applicable during drilling activities to access deep water formations.

7. The system of claim 1, wherein the grout system is applicable during drilling activities to access shale formations.

8. The system of claim 1, wherein the grout system is applicable to conventional sandstone and carbonate formations.

9. The system of claim 1, wherein the grout system, upon injection and curing, prevents fracture propagation and maintains wellbore stability.

10. The system of claim 1, wherein the grout system reduces fluid losses during drilling or completions activities, thereby minimizing operational disruptions and risks associated with uncontrollable fluid release.

11. The system of claim 1, wherein the grout system is injected using a single injection stream of pre-mixed grout.

12. The system of claim 1, wherein the grout system is injected using a simultaneous injection during which the grout is mixed while being pumped into a wellbore.

13. The system of claim 1, wherein the grout system is injected using flexible bladders or balloons containing the separate precursors are deployed through the drill string; upon shearing during passing through the drill bit apertures, the precursors are released and can react downhole, undergoing transit into the fracture

14. The system of claim 1, wherein the grout system is injected using encapsulated precursors configured to experience rupture or degradation of encapsulation, release the precursors, and adhere to the fractures.

15. The system of claim 1, wherein the grout system provides enhanced lost circulation control by creating an impermeable=or solid barrier upon curing.

16. A method for employing an expandable polyurethane grout system for controlling lost circulation during drilling operations, comprising:
deploying a mixture of one or more grout precursors into a downhole wellbore comprising one or more fractures;
wherein the combination of the grout precursors results in a chemical reaction that causes expansion of the grout;
wherein the expanded grout system undergoes a hardening polymerization to form a closed cell structure; and
wherein the expanded grout system physically adheres to one or more formation grains and the fracture faces.

17. The system of claim 16, wherein the grout is injected using a single injection stream of pre-mixed grout.

18. The system of claim 16, wherein the grout system is injected using a simultaneous injection during which the grout is mixed while being pumped into the wellbore.

19. The system of claim 16, wherein the grout system is injected using encapsulated precursors configured to dissolve, release the precursors, and adhere to the fractures.
